(19) United States
(12) Patent Application Publication
(10) Pub. No.: US 2010/0196797 A1
(43) Pub. Date: Aug. 5, 2010

(54) LIQUID SUPPLY CONTAINER AND FUEL CELL SYSTEM PROVIDED WITH THE SAME

(75) Inventors: Hidekazu Kimura, Tokyo (JP); Suguru Watanabe, Tokyo (JP); Toru Takahashi, Kanagawa (JP); Nobuo Katsuura, Kanagawa (JP); Minoru Murata, Tokyo (JP); Kiyoshi Isobe, Tokyo (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignees: NEC CORPORATION, Tokyo (JP); NIX, INC., Kanagawa (JP); TAKACHIHO ELECTRIC CO., LTD., Tokyo (JP)

(21) Appl. No.: 12/439,822

(22) PCT Filed: Sep. 4, 2007
(86) PCT No.: PCT/JP2007/067184

§ 371 Date: Mar. 3, 2009

(30) Foreign Application Priority Data
Sep. 5, 2006 (JP) 2006-240775

(51) Int. Cl. H01M 8/02; B65D 37/00

(52) U.S. Cl. 429/513; 222/92

(57) ABSTRACT

What is provided is a liquid supply container capable of minimizing, after the supply of liquid in a liquid reservoir to a liquid acceptor has been completed, the amount of the liquid remaining in the liquid reservoir. A liquid supply container 1 includes: a liquid reservoir 10 that changes its shape in accordance with the amount of liquid contained therein; and a liquid supply section 30 provided in the liquid reservoir 10 to supply the liquid to a liquid acceptor 50. The liquid supply section 30 includes: a liquid supply path 16 that supplies the liquid to the liquid acceptor 50; and an exposed surface 20 that defines a liquid reservoir 10-side end in the liquid supply path 16 and is exposed to the inner space of the liquid reservoir 10. The exposed surface 20 is provided with a recess capable of forming a flow path in which the liquid flows from the outer circumference of the exposed surface 20 to the liquid supply path 16. Also, a liquid supply container 2 has a recess or protrusion on the inner surface of the liquid reservoir 10, the recess or protrusion being capable of forming a flow path in which the liquid flows to the liquid supply path 16.

### TECHNICAL FIELD

The present invention relates to a liquid supply container that can various types of liquid such as liquid fuel used for a fuel cell and that supplies the liquid contained therein to a liquid accepting body, and to a fuel cell system provided with this liquid supply container.

### RELATED ART

A liquid supply container that contains a liquid and supplies the liquid contained therein to a liquid acceptor in various appliances has been widely used for, for example, various appliances using liquid fuel such as a fuel cell system, etc., and for liquid administration used in medical treatments. The liquid supply container itself can be replaced when it runs short of liquid to be supplied, so a user can refill the liquid supply container with the liquid easily and safely with one's hands hardly contaminated by the liquid. This liquid supply container is particularly effective in a situation where the liquid to be used may affect a human body or may severely deteriorate when exposed to the outside air.

Also, the development of fuel cells that generate electric power using a liquid as fuel is being promoted these days. In particular, many electric-appliance manufacturers are actively promoting the development of direct methanol fuel cells (DMFCs) that use methanol as fuel. The DMFCs are expected to be new batteries for the next generation that can be used for, for example, notebook personal computers, various portable electronics and cell phones. However, in general, methanol has a considerable affect on the human body. If a person inhales methanol, it may damage the central nervous system and cause dizziness and diarrhea. If a person inhales a large amount of methanol or methanol enters one's eyes, methanol may cause optic nerve disorder and there is a high possibility of loss of sight. Accordingly, methanol is a highly dangerous toxic liquid. Therefore, in order for general consumers of DMFCs to safely and easily supply fuel, a means of supplying methanol using a liquid supply container as a cartridge so that the consumers will not directly touch the methanol is considered to be the optimum means, and the development of such means is being widely promoted (see, for example, patent document 1 and patent document 2).

In such a liquid supply container, a method for sending a liquid using a pump, etc. is typically employed in order to efficiently supply the liquid contained in a liquid reservoir in this device to the liquid acceptor.

Also, for example, a fuel container (liquid supply container) for a fuel cell mechanism has been proposed, which includes a means of changing the volume of a fuel chamber in relation to the internal pressure of the fuel chamber, the means configured to generate pressure required for sending out the fuel from the fuel chamber without using a pump for the purpose of supplying the fuel to the mechanism that consumes the fuel (see, for example, patent document 3).

Patent document 1: JP2003-308871 A

Patent document 2: JP8-12301 A

Patent document 3: JP2000-314376 A

### DISCLOSURE OF THE INVENTION

### Problem to be Solved by the Invention

In conventional liquid supply containers, a liquid contained in a liquid reservoir is typically supplied to a liquid acceptor via a liquid supply port provided in the liquid reservoir. The liquid reservoir used herein changes its shape and reduces its internal volume in accordance with the supply amount of the liquid. However, in such liquid supply containers, when the liquid reservoir changes its shape in accordance with the reduction in the amount of the liquid remaining in the liquid reservoir, a part of the internal surface of the liquid reservoir blocks the liquid supply port in some cases. In other cases, parts of the internal surface of the liquid reservoir come into contact with each other and block a flow path for the remaining liquid in the liquid reservoir to reach the liquid supply port. Accordingly, the liquid contained in the liquid reservoir might not be used up completely.

This invention has been made in light of the above circumstances, and it is an object of this invention to provide a liquid supply container capable of minimizing the amount of liquid which remains in a liquid supply container after liquid supply from the liquid reservoir to a liquid acceptor has been completed.

### Means for Solving the Problem

In order to achieve the above object, according to an aspect of this invention, a liquid supply container includes: a liquid reservoir that can contain liquid inside and changes its shape in accordance with the amount of the liquid contained therein; and a liquid supply section that is provided in the liquid reservoir and supplies the liquid contained in the liquid reservoir to a liquid acceptor, in which: the liquid supply section includes: a liquid supply path that supplies the liquid contained in the liquid reservoir to the liquid acceptor; and an exposed surface that defines a liquid reservoir-side end in the liquid supply path and is exposed to the inner space of the liquid reservoir; and the exposed surface is provided with at least one recess capable of forming a flow path in which the liquid flows from the outer circumference of the exposed surface to the liquid supply path.

In the liquid supply container having the above-described configuration, the exposed surface in the liquid supply section is provided with the recess capable of forming the flow path in which the liquid flows from the outer circumference of the exposed surface to the liquid supply path. Accordingly, even if a part of the inner surface of the liquid reservoir comes into contact with the exposed surface in the liquid supply section when the liquid reservoir changes its shape in accordance with the reduction in the amount of the liquid remaining in the liquid reservoir, the recess serves as the flow path, so that the liquid can securely reach the liquid flow path. Consequently, the liquid contained in the liquid reservoir can be used sufficiently.

In the liquid supply container according to the aspect of this invention, the recess can be configured from a groove that has the outer circumference of the exposed surface communicate with the liquid supply path.

In the liquid supply container according to the aspect of this invention, a plurality of recesses can be formed. In this configuration, the plurality of recesses can be arranged with a gap therebetween and extend substantially radially with the liquid supply path positioned substantially at the center of the recesses. With this configuration, the liquid can reach the liquid supply path even more securely.

According to another aspect of this invention, a liquid supply container includes: a liquid reservoir that can contain liquid inside and changes its shape in accordance with the amount of the liquid contained therein; and a liquid supply section that is provided in the liquid reservoir and supplies the liquid contained in the liquid reservoir to a liquid acceptor, in which a recess or a protrusion is provided on an inner surface of the liquid reservoir, the recess or protrusion being capable of forming a flow path in which the liquid flows to the liquid supply path formed in the liquid supply section.

In the liquid supply container having the above-described configuration, the inner surface of the liquid reservoir is provided with a recess or protrusion capable of forming the flow path in which the liquid flows to the liquid supply path formed in the liquid supply section. Accordingly, even if parts of the inner surface of the liquid reservoir come into contact with each other when the liquid reservoir changes its shape in accordance with the reduction in the amount of the liquid remaining in the liquid reservoir, the recess or protrusion can serve as a flow path, so that the liquid can securely reach the liquid supply path. Consequently, the liquid contained in the liquid reservoir can be used sufficiently.

In the liquid supply container according to the aspect of this invention, the recess can be configured from a groove extending from the vicinity of an end opposite to the side provided with the liquid supply path in the liquid reservoir toward the liquid supply section.

In the liquid supply container according to the aspect of this invention, the protrusion can be configured from a rib extending from the vicinity of an end opposite to the side provided with the liquid supply path in the liquid reservoir toward the liquid supply section.

In the liquid supply container according to the aspect of this invention, the liquid supply section can be configured to include an exposed surface that defines a liquid reservoir-side end in the liquid supply path and is exposed to the inner space of the liquid reservoir, the exposed surface being provided with at least one second recess capable of forming a flow path in which the liquid flows from the outer circumference of the exposed surface to the liquid supply path. With this configuration, the liquid can reach the liquid supply path even more securely, and therefore the liquid contained in the liquid reservoir can be used even more sufficiently.

In the liquid supply container according to the aspect of this invention, the second recess can be configured from a groove that has the outer circumference of the exposed surface communicate with the liquid supply path.

In the liquid supply container according to the aspect of this invention, a plurality of second recesses can be provided. In this configuration, the plurality of second recesses can be arranged with a gap therebetween and extend substantially radially with the liquid supply path positioned substantially at the center of the second recesses. With this configuration, the liquid can reach the liquid supply path even more securely, and the liquid contained in the liquid reservoir can be used even more sufficiently.

According to another aspect of this invention, a fuel cell system includes: a fuel cell; the above-described liquid supply container according to the above aspect of this invention; liquid fuel contained in the liquid supply container; and a liquid acceptor that accepts the liquid fuel supplied from the liquid supply container, in which electric power is generated using the liquid fuel supplied to the liquid acceptor.

In the fuel cell system having the above configuration, the flow path in which the liquid flows can be formed between the liquid reservoir and the liquid supply path in the liquid supply section when the liquid reservoir changes its shape in accordance with the reduction in the amount of the liquid remaining in the liquid reservoir, so that the liquid can securely reach the liquid supply path. Accordingly, the liquid contained in the liquid reservoir can be used even more sufficiently.

### EFFECT OF THE INVENTION

In the liquid supply container according to this invention, the exposed surface in the liquid supply section is provided with a recess capable of forming a flow path in which the liquid flows from the outer circumference of the exposed surface to the liquid supply path. Accordingly, even if a part of the liquid reservoir comes into contact with the exposed surface in the liquid supply section when the liquid reservoir changes its shape in accordance with the reduction in the amount of the liquid remaining in the liquid reservoir, the recess can serve as the flow path, so that the liquid can securely reach the liquid supply path. Consequently, the liquid contained in the liquid reservoir can be used sufficiently and economically.

The liquid supply container according to this invention can contain liquid fuel used for a fuel cell in the liquid reservoir.

In the liquid supply container according to this invention, the inner surface of the liquid reservoir is provided with a recess or protrusion capable of forming a flow path in which the liquid flows to the liquid supply path provided in the liquid supply section. With this configuration, even if parts of the inner surface of the liquid reservoir come into contact with each other when the liquid reservoir changes its shape in accordance with the reduction in the amount of the liquid remaining in the liquid reservoir, the recess or protrusion serves as the flow path, so that the liquid can securely reach the liquid supply path. Consequently, the liquid contained in the liquid reservoir can be used sufficiently and economically.

In the liquid fuel system according to this invention, the flow path in which the liquid flows can be formed between the liquid reservoir and the liquid supply path in the liquid supply section when the liquid reservoir changes its shape in accordance with the reduction in the amount of the liquid remaining in the liquid reservoir. Accordingly, the liquid can securely reach the liquid supply path. Consequently, the liquid contained in the liquid reservoir can be used even more sufficiently and economically.

### BEST MODE FOR CARRYING OUT THE INVENTION

A liquid supply container according to preferred embodiments in this invention and a fuel cell system provided with this liquid supply container will be described with reference to the attached drawings. Note that the embodiments described below are examples for illustrating this invention, and these embodiments are not intended to limit this invention.

Accordingly, this invention can be implemented in various ways as long as it does not depart from the gist of this invention.

### Embodiment 1

FIG. 1 is a perspective view showing a liquid supply container according to embodiment 1 in this invention. FIG. 2 is a side view showing the liquid supply container shown in FIG. 1. FIG. 3 is a cross sectional view taken along line III-III in FIG. 2 and showing an area around a liquid supply section in the liquid supply container in an enlarged manner. FIG. 4 is a plan view showing the liquid supply container in FIG. 3, viewed from inside a liquid reservoir. FIG. 5 is a cross sectional view taken along line V-V in FIG. 3, which only shows the liquid supply section. FIG. 6 is a perspective view showing the liquid supply container in FIG. 1 and showing the state where about 80% of liquid contained in the liquid reservoir has been consumed.

FIG. 7 is a schematic view showing a fuel cell system provided with the liquid supply container according to embodiment 1 in this invention.

Embodiment 1 describes an example in which liquid fuel to be used for a fuel cell is contained in a liquid reservoir in a liquid supply container and this liquid fuel is supplied to a liquid acceptor in the fuel cell.

As shown in FIGS. 1 to 6, a liquid supply container 1 in embodiment 1 includes: a liquid reservoir 10 that can contain liquid fuel therein; and a liquid supply section 30 that is provided in the liquid reservoir 10 and supplies the liquid fuel contained in the liquid reservoir 10 to a liquid accepting section (liquid acceptor) 50 in a fuel cell 100 that is configured as a separate body from the liquid supply container 1.

The liquid reservoir 10 has a pair of lateral sides 13A and 13B arranged opposite to each other. The liquid reservoir 10 is configured from a bag which has a substantially rectangular solid shape when filled with the liquid fuel. The pair of lateral sides 13A and 13B has a gusset bag structure. In other words, as shown in FIG. 6, the lateral sides 13A and 13B are configured so as to be folded substantially in a V shape toward the inside of the liquid reservoir 10 with fold lines 15A and 15B in the gusset bag structure serving as tops. With this configuration, the liquid reservoir 10 changes its shape with its lateral sides 13A and 13B folded substantially in V shape toward the inside of the liquid reservoir 10 in accordance with the amount of the liquid remaining therein.

The liquid supply section 30 is provided in a surface different from the lateral sides 13A and 13B in the liquid reservoir 10 (an end surface in the longitudinal direction in embodiment 1). This liquid supply section 30 has a hollow cylindrical shape, and the hollow part that opens along the axis defines a liquid supply path 16 for supplying the liquid fuel contained in the liquid reservoir 10 to the liquid accepting section 50. Although not shown, the liquid supply section 30 is configured in such a manner that the liquid can flow through the liquid supply path 16 when the liquid supply section 30 is connected to the liquid accepting section 50, in order to prevent the liquid fuel contained in the liquid reservoir 10 from accidentally leaking outside.

The liquid fuel is supplied to the liquid accepting section 50 via the liquid supply path 16 in the liquid supply section 30 in an amount required in the liquid accepting section 50. Here, if an area occupied by the liquid supply section 30 is large with respect to the liquid reservoir 10, misalignment in the attachment of the liquid supply section 30 to the liquid reservoir 10 will very likely occur, which might cause faulty sealing and consequently increase the risk of liquid leakage. One conceivable way to prevent the occurrence of misalignment in the attachment of the liquid supply section 30 to the liquid reservoir 10 is to minimize the area occupied by the liquid supply section 30 with respect to the liquid reservoir 10. In embodiment 1, the liquid supply section 30 is configured to have a hollow and substantially cylindrical shape with the minimum size required for efficiently supplying the liquid fuel in an amount required in the liquid accepting section 50, as shown in FIGS. 1 to 5.

An end surface in the liquid supply section 30, which is arranged on the liquid reservoir 10 side, defines an exposed surface 20 exposed to the inner space of the liquid reservoir 10. Substantially the center of this exposed surface 20 defines a liquid reservoir 10-side opening in the liquid supply path 16 and also defines a liquid reservoir 10-side end in the liquid supply path 16. This exposed surface 20 is concentric with the liquid supply path 16 and is provided with eight grooves 18A to 18H that extend radially from the liquid supply path 16. These grooves 18A to 18H reach the outer circumference of the exposed surface 20 and serve as flow paths in which the liquid fuel flows from the outer circumference of the exposed surface 20 to the liquid supply path 16. Note that the liquid supply section 30 can be attached to the liquid reservoir 10 by, for example, fixing an exposed surface 20-side end surface in the liquid supply section 30 to the liquid reservoir 10 through adhesion or welding.

In the liquid supply container 1 having the above-described configuration, in accordance with the reduction in the amount of the liquid fuel contained in the liquid reservoir 10, the pair of lateral sides 13A and 13B is folded inward (see FIG. 6), and the liquid reservoir 10 changes its shape and reduces its internal volume. When the amount of the liquid fuel remaining in the liquid reservoir 10 becomes small, a part of the internal surface of the liquid reservoir 10 sometimes comes into contact with the exposed surface 20 in the liquid supply section 30. However, even in such a situation, at least one of the grooves 18A to 18H serves as a flow path, so that the liquid fuel can securely reach the liquid supply path 16. Accordingly, the liquid fuel contained in the liquid reservoir 10 can be used up without waste.

Next, the configuration in which the liquid supply container according to embodiment 1 is applied in a fuel cell system will be described below with reference to FIG. 7.

A fuel cell system according to embodiment 1 includes: a fuel cell 100, the liquid supply container 1 connected to an inlet 150 in the liquid accepting section 50 for supplying fuel (liquid fuel in embodiment 1) to an anode in the fuel cell 100; an oxygen gas source 200 connected to an inlet 103 in an air supply section 101 for supplying oxygen gas (normally, air) to a cathode in the fuel cell 100. Note that the reference numeral 102 denotes an off-gas exhaust port for exhausting off-gas exhausted from the anode in the fuel cell 100 to the outside, the reference numeral 104 denotes an off-gas exhaust port for exhausting off gas exhausted from the cathode in the fuel cell 100 to the outside, and the reference numeral 201 denotes an oxygen gas injection port for the oxygen gas source 200.

In FIG. 7, the liquid supply section 30 in the liquid supply container 1 and the inlet 150 in the liquid accepting section 50 are connected to each other via an arrow, just for convenience of explanation. However, in fact, the liquid supply section 30 and the inlet 150 may be connected to each other directly or via a connector such as a pipe and tube. The same applies to the oxygen gas injection port 201 and the oxygen gas inlet 103. The oxygen gas source 200 may be, for example, a container such as a tank that reserves oxygen gas therein or may supply the air directly from the atmospheric air.

Various types of fuel cells may be used as the fuel cell 100. In embodiment 1, a DMFC is used and methanol is contained (reserved) in the liquid reservoir 10 in the liquid supply container 1.

When electric power is generated by the fuel cell system having the above-described configuration, the liquid fuel contained in the liquid reservoir 10 in the liquid supply container 1 is supplied to the liquid accepting section 50 via the liquid supply section 30. This liquid fuel is pumped by a pump or the like (not shown) normally provided in the fuel cell system and thereby supplied from the liquid reservoir 10 to the liquid accepting section 50. The fuel cell 100 then generates electric power through an electrochemical reaction between a hydrogen ion that has come out from the liquid fuel supplied to the liquid accepting section 50 and oxygen supplied from the oxygen gas source 200 (or air supplied directly from the atmospheric air).

When the liquid fuel contained in the liquid reservoir 10 is consumed and the liquid fuel remaining in the liquid reservoir 10 decreases with the progress of the electric power generation, the liquid reservoir 10 is folded as shown in FIG. 6 in accordance with the reduction in the amount of the liquid fuel as described above. At this time, even if a part of the inner surface of the liquid reservoir 10 comes into contact with the exposed surface 20 in the liquid supply section 30, at least one of the grooves 18A to 18H can serve as a flow path, so that the liquid fuel can securely reach the liquid supply path 16. Accordingly, the liquid fuel contained in the liquid reservoir 10 can be used up without waste and thus economically.

In this instance, if, for example, an electronic appliance with the wattage of 1 W is operated using the fuel cell system in this invention, the reduction of 1 ml loss in the liquid fuel enables the fuel cell life to be prolonged for about one hour.

Although the configuration in which the exposed surface 20 of the liquid supply section 30 is provided with eight grooves 18A to 18H radially extending from the liquid supply path 16 and thereby configuring the flow paths in which the liquid fuel flows from the outer circumference of the exposed surface 20 to the liquid supply path 16 is described in embodiment 1, this invention is not limited to this configuration, and the number, size, shape, etc. of the grooves may be arbitrarily determined as long as the flow paths in which the liquid flows from the outer circumference of the exposed surface 20 to the liquid supply path 16 can be formed. Alternatively, for example, the exposed surface 20 may be provided with a plurality of protrusions 19 as shown in FIG. 8 so that the exposed surface 20 serves as a recess relative to the protrusions 19, and this relative recess may be used as a flow path in which the liquid flows from the outer circumference of the exposed surface 20 to the liquid supply path 16.

Alternatively, the liquid supply section 30 may be configured from: a liquid supply main body 31 provided with the liquid supply path 16; and a cap 32 that is attached to an end surface of the liquid supply main body 31, in which the surface opposite to the surface attached to the liquid supply main body 31 in the cap 32, when the cap 32 is attached to the liquid supply main body 31, serves as the exposed surface 20. Substantially the center of the cap 32 defines a liquid reservoir 10-side opening in the liquid supply path 16 and also defines a liquid reservoir 10-side end in the liquid supply path 16. The exposed surface 20 is provided with the eight grooves 18A to 18H extending radially from the liquid supply path 16. These grooves 18A to 18H reach the outer circumference of the exposed surface 20 and define the flow paths in which the liquid fuel flows from the outer circumference of the exposed surface 20 to the liquid supply path 16.

The position in which the liquid supply section 30 is arranged may be arbitrarily determined.

Although, in embodiment 1, the liquid reservoir 10 is configured from a bag that has a substantially rectangular solid shape when filled with the liquid fuel and is folded as shown in FIG. 6 as the liquid fuel is consumed, the liquid reservoir 10 is not limited to this configuration. The liquid reservoir 10 may have other shapes as long as it can contain liquid inside and can change its shape in accordance with the amount of the liquid contained therein.

The liquid reservoir 10 should obviously be made of a material that is resistant to liquid to be contained therein, and in addition, the liquid reservoir 10 is preferably made of a material that easily allows the lateral sides 13A and 13B to be folded inward in accordance with the reduction of the liquid. The thickness and the like of the container configuring the liquid reservoir 10 (a bag in embodiment 1) may be arbitrarily determined.

Although the liquid fuel to be used for the fuel cell 100 is contained in the liquid reservoir 10 in embodiment 1, the liquid to be contained in the liquid reservoir 10 is not limited to the above liquid fuel and may be arbitrarily selected as desired.

### Embodiment 2

Next, a liquid supply container according to embodiment 2 in this invention will be described with reference to the attached drawings. In embodiment 2, like reference numerals are assigned to like components that have been described in embodiment 1 and their detailed descriptions will be omitted.

FIG. 10 is a perspective view showing a liquid supply container according to embodiment 2. FIG. 11 is a side view showing the liquid supply container shown in FIG. 10. FIG. 12 is a cross sectional view taken along line XII-XII in FIG. 11. FIG. 13 is a cross sectional view taken along line XIII-XIII in FIG. 12.

As shown in FIGS. 10 to 13, a liquid supply container 2 in embodiment 2 is different from the liquid supply container 1 in embodiment 1 mainly in that ribs 25A and 25B are provided on the inner surface of the liquid reservoir 10 and in the position and shape of a liquid supply section 40.

The rib 25A is formed on a surface provided with the liquid supply section 40 in the liquid reservoir 10 (the upper inner wall in FIGS. 10 to 13) and at a position closer to the lateral side 13B than to the liquid supply section 40. On the other hand, the rib 25B is formed on a surface opposite to the surface provided with the rib 25A (the bottom inner wall in FIGS. 10 to 13) and at a position closer to the lateral side 13A than to the liquid supply section 40. These ribs 25A and 25B each have an elongated shape along a longitudinal direction of the liquid reservoir 10. The ribs 25A and 25B may be formed integrally with the liquid reservoir 10, or may be formed separately from the liquid reservoir 10 and fixed to the liquid reservoir 10 using an adhesive such as an epoxide-based adhesive and an acrylic-based adhesive, heat sealing, and the like.

The liquid supply section 40 is provided in the upper surface in FIGS. 10 to 13 of the liquid reservoir 10 and has a hollow and substantially cylindrical shape. The hollow portion opening along the axial direction serves as the liquid supply path 16 for supplying liquid fuel contained in the liquid reservoir 10 to the liquid accepting section 50.

In the liquid supply container 2 having the above-described configuration, the pair of lateral sides 13A and 13B is folded inward (see FIG. 6) in accordance with the reduction in the amount of the liquid fuel contained in the liquid reservoir 10, and the liquid reservoir 10 thereby changes its shape and reduces its internal volume, like in the liquid supply container 1 described in embodiment 1. When the amount of the liquid fuel remaining in the liquid reservoir 10 becomes small, parts of the internal surface of the liquid reservoir 10 come close to being in contact with each other. In this instance, even if a part of the internal surface of the liquid reservoir 10 comes into contact with another part of the internal surface of the liquid reservoir 10, a flow path for the liquid fuel is secured in the liquid reservoir 10 by the ribs 25A and 25B. With this configuration the liquid fuel contained in the liquid reservoir 10 can securely reach the liquid supply path 16. Accordingly, the liquid fuel contained in the liquid reservoir 10 can be used up without waste.

The liquid supply section 40 is provided in the liquid reservoir 10 that has the inner surfaces provided with the ribs 25A and 25B in embodiment 2, but this invention is not limited to this configuration. The liquid supply section 30 described in embodiment 1 may be provided in the liquid reservoir 10 that has the inner surfaces provided with the ribs 25A and 25B. With this configuration, the flow path for the liquid fuel can be secured even more securely, and so the liquid fuel can reach the liquid supply path 16 even more securely.

Although two ribs 25A and 25B are formed on the inner surfaces of the liquid reservoir 10 in embodiment 2, this invention is not limited to this configuration. The number, position, size, shape, etc. of the ribs formed on the inner surface of the liquid reservoir 10 may be arbitrarily determined. In addition, projections other than the ribs may be formed on the inner surfaces of the liquid reservoir 10. Alternatively, for example, recesses such as grooves 35A and 35B in FIG. 14 may be formed. In such a configuration, the recesses such as the grooves 35A and 35B serve as flow paths for guiding the liquid fuel to the liquid supply path 16. The inner surface of the liquid reservoir 10 may be embossed (embossing is a processing for forming projections and dents by stamping, etc., on a surface of an object). In such embossing, the difference between the projections and dents may be arbitrarily set as desired, but it is preferable to set it to around the range from 0.1 to 10 mm. It is more preferable to set the difference between the projections and dents to around the range from 0.5 to 5 mm.

The liquid supply container 2 can also be used for the fuel cell system, such as the liquid supply container 1.

### BRIEF DESCRIPTION OF THE DRAWINGS

FIG. 1 is a perspective view showing a liquid supply container according to embodiment 1 in this invention.

FIG. 2 is a side view showing the liquid supply container in FIG. 1.

FIG. 3 is a cross sectional view taken along line in FIG. 2 and showing an area around a liquid supply section in the liquid supply container.

FIG. 4 is a plan view of the liquid supply section in FIG. 3 viewed from inside a liquid reservoir.

FIG. 5 is a cross sectional view taken along line V-V in FIG. 3 and only showing the liquid supply section.

FIG. 6 is a perspective view showing the liquid supply container in FIG. 1 in the state where 80% of liquid contained in the liquid reservoir has been consumed.

FIG. 7 is a schematic view showing a fuel cell system provided with the liquid supply container according to embodiment 1 in this invention.

FIG. 8 is a plan view showing a liquid supply section, viewed from inside a liquid reservoir, in a liquid supply container according to another embodiment in this invention.

FIG. 9 is an exploded view showing the cross sectional view of a liquid supply section in a liquid supply container according to another embodiment in this invention.

FIG. 10 is a perspective view showing a liquid supply container according to embodiment 2.

FIG. 11 is a side view showing the liquid supply container in FIG. 10.

FIG. 12 is a cross sectional view taken along line XII-XII in FIG. 11.

FIG. 13 is a cross sectional view taken along line XIII-XIII in FIG. 12.

FIG. 14 is a cross sectional view corresponding to FIG. 12, the cross sectional view showing a liquid supply container according to another embodiment in this invention.

FIG. 15 is a cross sectional view corresponding to FIG. 13, the cross sectional view showing a liquid supply container according to another embodiment in this invention.

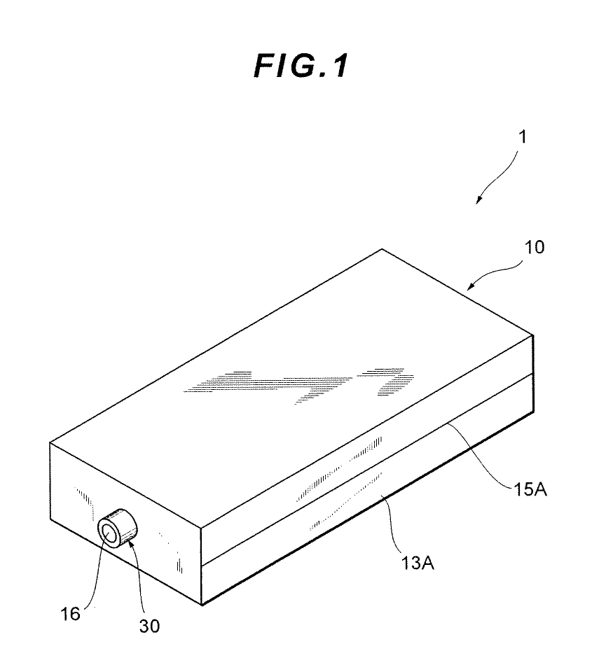

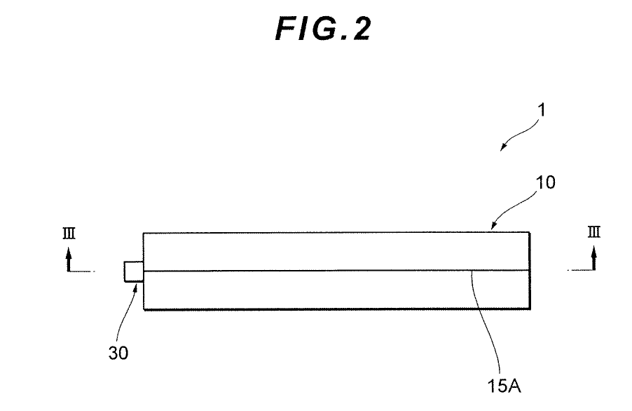

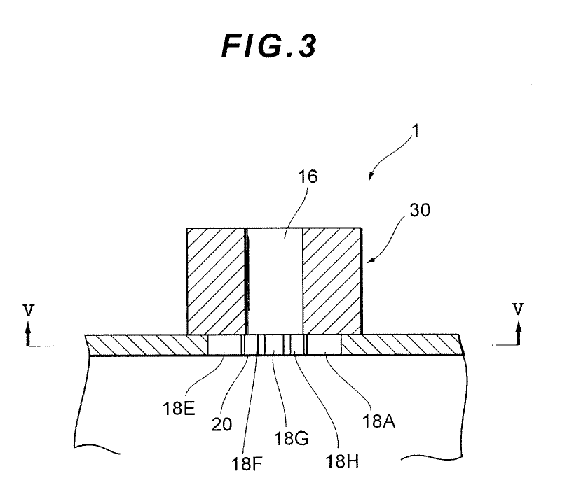

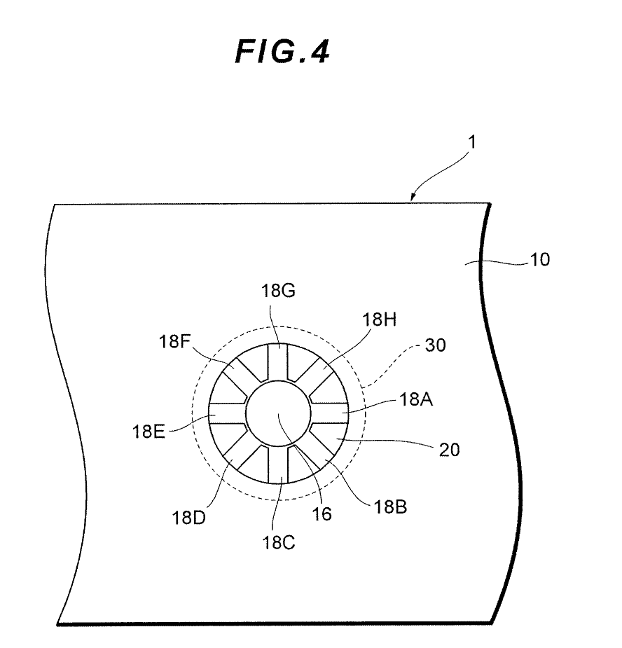

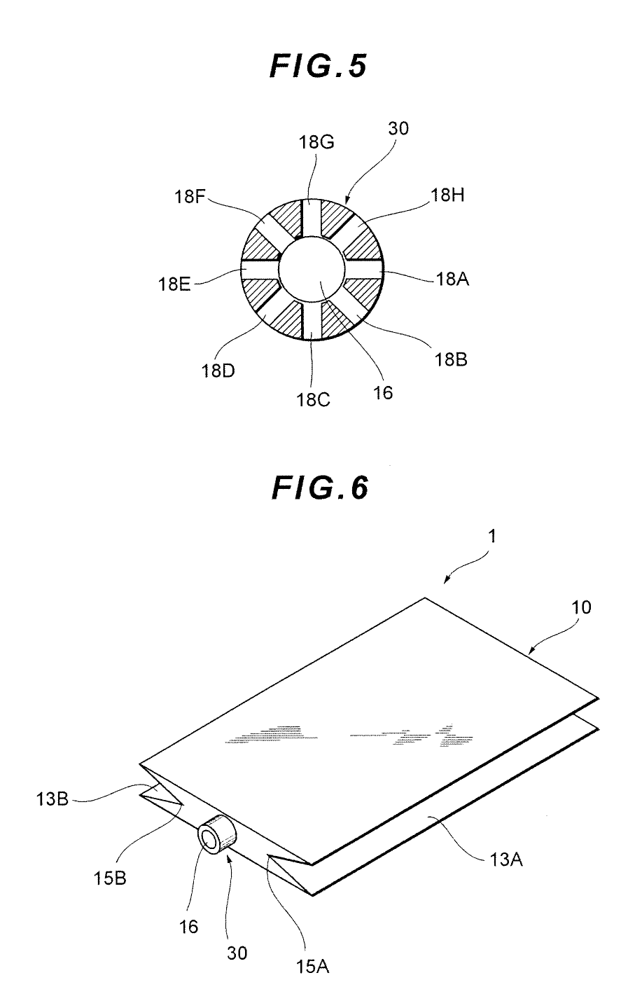

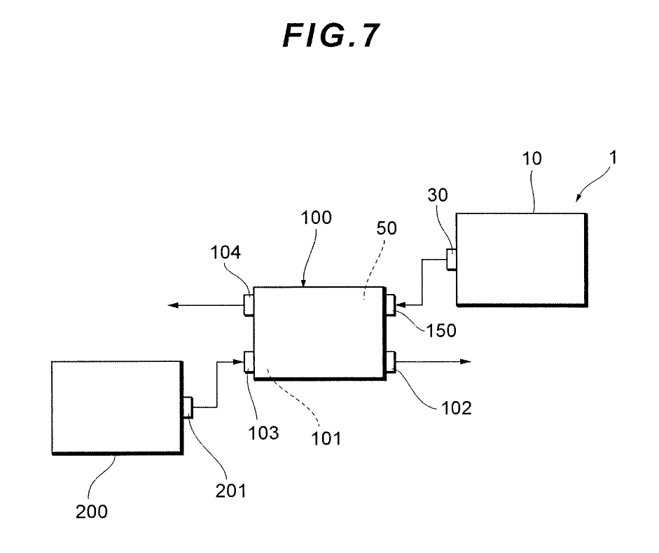

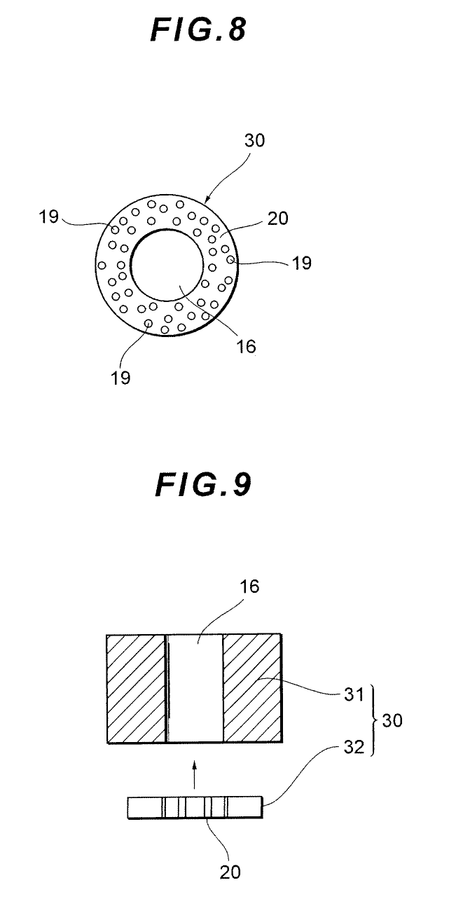

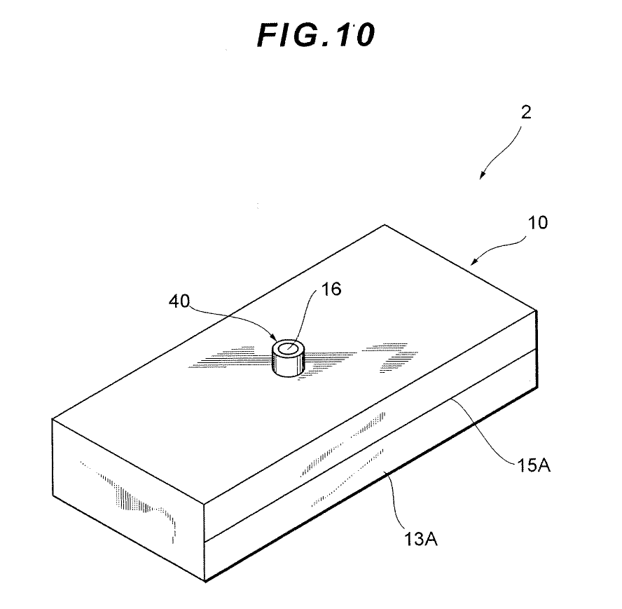

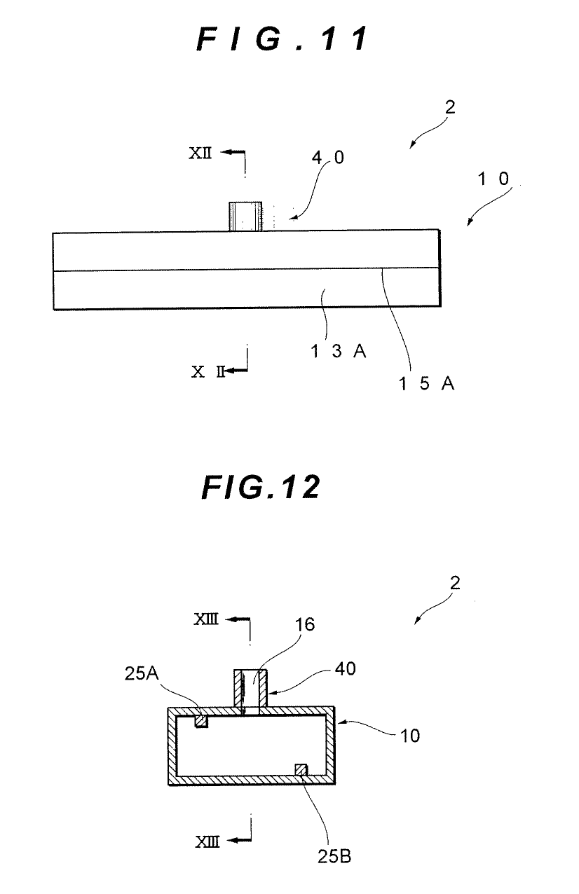

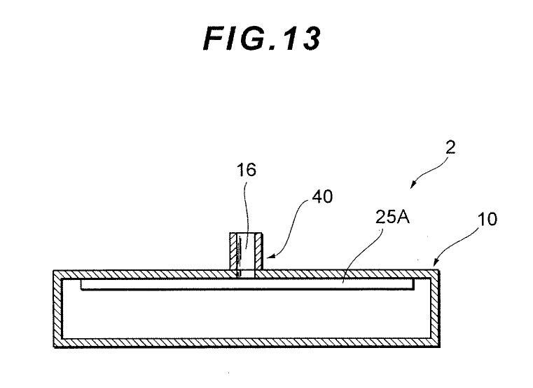

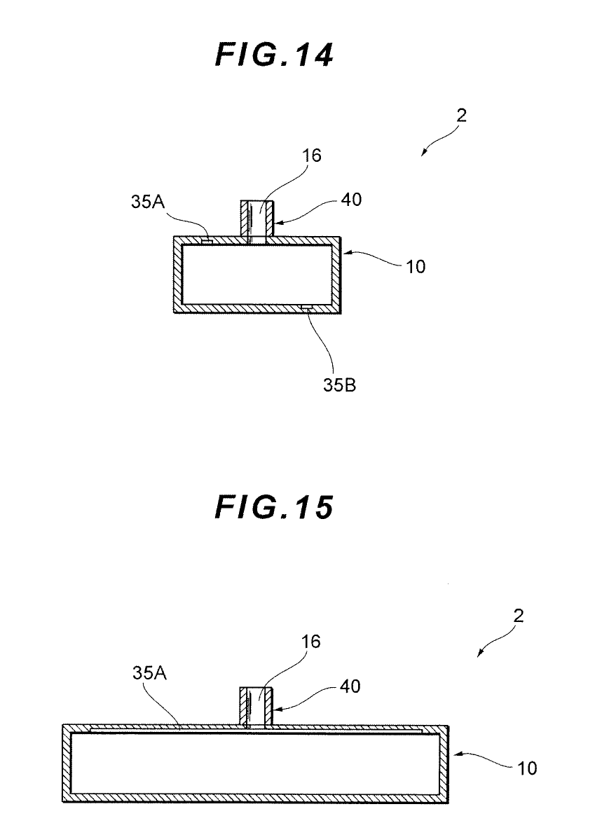

1. A liquid supply container, comprising:
a liquid reservoir that can contain liquid inside and changes its shape in accordance with the amount of the liquid contained therein; and
a liquid supply section that is provided in the liquid reservoir and supplies the liquid contained in the liquid reservoir to a liquid acceptor,
wherein the liquid supply section includes: a liquid supply path that supplies the liquid contained in the liquid reservoir to the liquid acceptor; and an exposed surface that defines a liquid reservoir-side end in the liquid supply path and is exposed to the inner space of the liquid reservoir, and
wherein the exposed surface is provided with at least one recess capable of forming a flow path in which the liquid flows from the outer circumference of the exposed surface to the liquid supply path.

2. The liquid supply container according to claim 1, wherein the at least one recess is a groove that has the outer circumference of the exposed surface communicate with the liquid supply path.

3. The liquid supply container according to claim 1, wherein the recesses are arranged radially with a gap therebetween and extend substantially radially with the liquid supply path positioned substantially at the center of the recesses.

4. A liquid supply container, comprising:
a liquid reservoir that can contain liquid inside and changes its shape in accordance with the amount of the liquid contained therein; and
a liquid supply section that is provided in the liquid reservoir and supplies the liquid contained in the liquid reservoir to a liquid acceptor,
wherein a recess or a protrusion is provided on an inner surface of the liquid reservoir, the recess or protrusion being capable of forming a flow path in which the liquid flows to the liquid supply path formed in the liquid supply section.

5. The liquid supply container according to claim 4, wherein the recess is a groove extending from the vicinity of an end opposite to the side provided with the liquid supply path in the liquid reservoir toward the liquid supply section.

6. The liquid supply container according to claim 4, wherein the protrusion is a rib extending from the vicinity of an end opposite to the side provided with the liquid supply path in the liquid reservoir toward the liquid supply section.

7. The liquid supply container according to claim 4, wherein
the liquid supply section includes an exposed surface that defines a liquid reservoir-side end in the liquid supply path and is exposed to the inner space of the liquid reservoir, and
wherein the exposed surface is provided with at least one second recess capable of forming a flow path in which the liquid flows from the outer circumference of the exposed surface to the liquid supply path.

8. The liquid supply container according to claim 7, wherein the at least one second recess is a groove that has the outer circumference of the exposed surface communicate with the liquid supply path.

9. The liquid supply container according to claim 7, wherein the second recesses are arranged with a gap therebetween and extend radially with the liquid supply path positioned substantially at the center of the second recesses.

10. The liquid supply container according to claim 1, wherein the liquid is liquid fuel used for a fuel cell.

11. A fuel cell system, comprising:
a fuel cell;
the liquid supply container according to claim 1;
liquid fuel contained in the liquid supply container; and
a liquid acceptor that accepts the liquid fuel supplied from the liquid supply container,
wherein electric power is generated using the liquid fuel supplied to the liquid acceptor.
